(19) United States
(12) Patent Application Publication
(10) Pub. No.: US 2026/0037777 A1
(43) Pub. Date: Feb. 5, 2026

(54) ENSEMBLE MACHINE LEARNING MODEL FOR EMAIL CYBERSECURITY SYSTEM

(71) Applicant: Intuit Inc., Mountain View, CA (US)

(72) Inventors: Natalie BAR ELIYAHU, Petah Tikva (IL); Omer WOSNER, Petah Tikva (IL); Hadas BAUMER, Petah Tikva (IL); Shon MENDELSON, Petah Tikva (IL)

(73) Assignee: Intuit Inc., Mountain View, CA (US)

(21) Appl. No.: 18/791,396

(22) Filed: Jul. 31, 2024

(51) Int. Cl. G06N 3/0455; G06N 3/08

(52) U.S. Cl. CPC G06N 3/0455; G06N 3/08

(57) ABSTRACT

A method for training an ensemble machine learning model. The method includes applying a first language model to a training data set, having emails stored in a non-transitory computer readable storage medium, to split email addresses in the emails into gibberish email addresses and non-gibberish email addresses. The gibberish email addresses include a first text string that the first language model classifies as gibberish. The non-gibberish email addresses include a second text string that the first language model classifies as non-gibberish. The method also includes training a second language model on the gibberish email addresses. The second language model is trained to determine whether the gibberish email addresses are valid or invalid. The method also includes training a third language model on the non-gibberish email addresses. The third language model is trained to determine whether the non-gibberish email addresses are valid or invalid.

### BACKGROUND

Distinguishing between valid and invalid email addresses is a difficult technical problem in computer science. Distinguishing valid and invalid email addresses may be one component of an email cybersecurity system. For example, if an email has an invalid email address, then the email may be marked as invalid and a security action taken (e.g., delete the email, block the email address, etc.).

While an attempt at validating an email may be made by sending a confirmation email to a suspect email address and requesting a read receipt, such validation may be impractical, inadvisable, or unreliable. For example, email addresses may be spoofed (making the validation procedure inadvisable) or may exist as a body of stored emails from which it is desired to remove invalid emails (making validation impractical). Furthermore, such validation procedures may be unreliable, as a returned email from a spoofed email address may incorrectly cause an email to be labeled as valid, and a failure to validate an email may incorrectly cause an email to be labeled as invalid.

Validating email addresses is further complicated by the fact that email addresses may include gibberish (i.e., non-sensical or seemingly random text, such as “17652abc@serverprovider.com”) or non-gibberish (i.e., human readable text, such as “firstname.lastname@serverprovider.com”). While a higher percentage of invalid email addresses may include gibberish email addresses, many valid email addresses are gibberish email addresses. Thus, email addresses may not be labeled as valid or invalid merely because the email addresses are gibberish or contain gibberish, thereby complicating the email address validation problem.

Hence, a technical problem exists in computer science. The technical problem is how to program a computer to determine whether email addresses are valid or invalid without requesting return receipts from the email addresses.

### SUMMARY

One or more embodiments provide for a method for training an ensemble machine learning model. The method includes applying a first language model to a training data set, having emails stored in a non-transitory computer readable storage medium, to split email addresses in the emails into gibberish email addresses and non-gibberish email addresses. The gibberish email addresses include a first text string that the first language model classifies as gibberish. The non-gibberish email addresses include a second text string that the first language model classifies as non-gibberish. The method also includes training a second language model on the gibberish email addresses. The second language model is trained to determine whether the gibberish email addresses are valid or invalid. The method also includes training a third language model on the non-gibberish email addresses. The third language model is trained to determine whether the non-gibberish email addresses are valid or invalid.

One or more embodiments also provide for a system. The system includes a computer processor and a data repository in communication with the computer processor. The data repository stores a training data set including emails. The data repository also stores gibberish email addresses of the emails. The gibberish email addresses include first text strings that are classified as nonsensical or meaningless. The data repository also stores non-gibberish email addresses of the emails. The non-gibberish email address include second text strings that are classified as non-gibberish. The system also includes a first language model which, when executed by the computer processor, performs computer-implemented steps. The computer-implemented steps include splitting the emails into the gibberish email addresses and the non-gibberish email addresses. The system also includes a training controller which, when executed by the computer processor, performs computer-implemented steps including training a second language model on the gibberish email addresses. The second language model is trained to determine whether the gibberish email addresses are valid or invalid. The computer-implemented steps also include training a third language model on the non-gibberish email addresses. The third language model is trained to determine whether the non-gibberish email addresses are valid or invalid.

One or more embodiments provide for another method. The method includes receiving a test email at a server controller and extracting a test email address from the test email. The method also includes executing a trained gibberish language model, trained on gibberish email addresses, on the test email address to generate a first classification whether the test email address is valid or invalid. The method also includes executing a trained non-gibberish language model, trained on non-gibberish email address, on the test email address to generate a second classification whether the test email address is valid or invalid. At least one of the trained gibberish language model and the trained non-gibberish language model includes a bidirectional encoder representations from transformers (BERT) model augmented with a fully connected layer, a neuron layer including at least two neurons, and a softmax layer as a final layer. The method also includes classifying the test email address as invalid when either the trained gibberish language model or the trained non-gibberish language model classifies the test email address as invalid. The method also includes classifying the test email address as valid when both the trained gibberish language model and the trained non-gibberish language model classify the test email address as valid. The method also includes performing a security action with respect to the test email address when the test email address is classified as invalid. The method also includes performing a non-security action with respect to the test email address when the test email address is classified as valid.

Other aspects of one or more embodiments will be apparent from the following description and the appended claims.

### BRIEF DESCRIPTION OF DRAWINGS

FIG. 1A and FIG. 1B show a computing system, in accordance with one or more embodiments.

FIG. 2 and FIG. 3 show flowcharts of a method for training and using an ensemble machine learning model for email cybersecurity, in accordance with one or more embodiments.

FIG. 4A, FIG. 4B, FIG. 4C, and FIG. 4D show an example of an ensemble machine learning model for email cybersecurity, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to technical solutions to the technical problem of how to program a computer to determine whether email addresses are valid or invalid without requesting return receipts from the email addresses. The technical solution involves training multiple language models (e.g., large language models such as CHATGPT®) to predict whether an email address is valid or invalid.

Training one language model to predict whether an email address is valid or invalid may result in a trained language model that is insufficiently accurate. The term “insufficiently accurate” means that the trained language model's prediction error rate is above a pre-defined threshold value. For example, a cybersecurity program may require an error rate of less than one percent when predicting whether an email address is valid or invalid, but training a single language model to predict the validity of email addresses will not achieve such an accuracy.

One or more embodiments approach the technical problem of training a language model to predict the validity of email addresses by fine-tuning the training of multiple language models. Training begins with a first language model classifying training email addresses as gibberish and non-gibberish. Note that each of the gibberish email addresses and the non-gibberish email addresses may include both valid and invalid email addresses. Then, a second language model is trained on the gibberish email addresses, resulting in a trained gibberish language model. Similarly, a third language model is trained on the non-gibberish email addresses, resulting in a trained non-gibberish language model. Additional accuracy may be achieved by specifying the layering of the language models, as further with respect to the figures.

The above-described procedure may be referred to as fine-tuning the language models. The fine-tuned language models have a much greater accuracy at predicting the validity of email addresses, relative to the use of a single language model as the effects of gibberish or non-gibberish email addresses are taken into account during the fine-tuning of the language models.

Thereafter, the trained gibberish language model and the trained non-gibberish language model may be used in tandem to predict whether a test email (e.g., an incoming email, an email address in a data repository, etc.) is valid or invalid. If either model predicts that the test email is invalid, then the test email is labeled as invalid and action may be taken accordingly. If both models predict that the test email is valid, then the test email is labeled as valid and action may be taken accordingly.

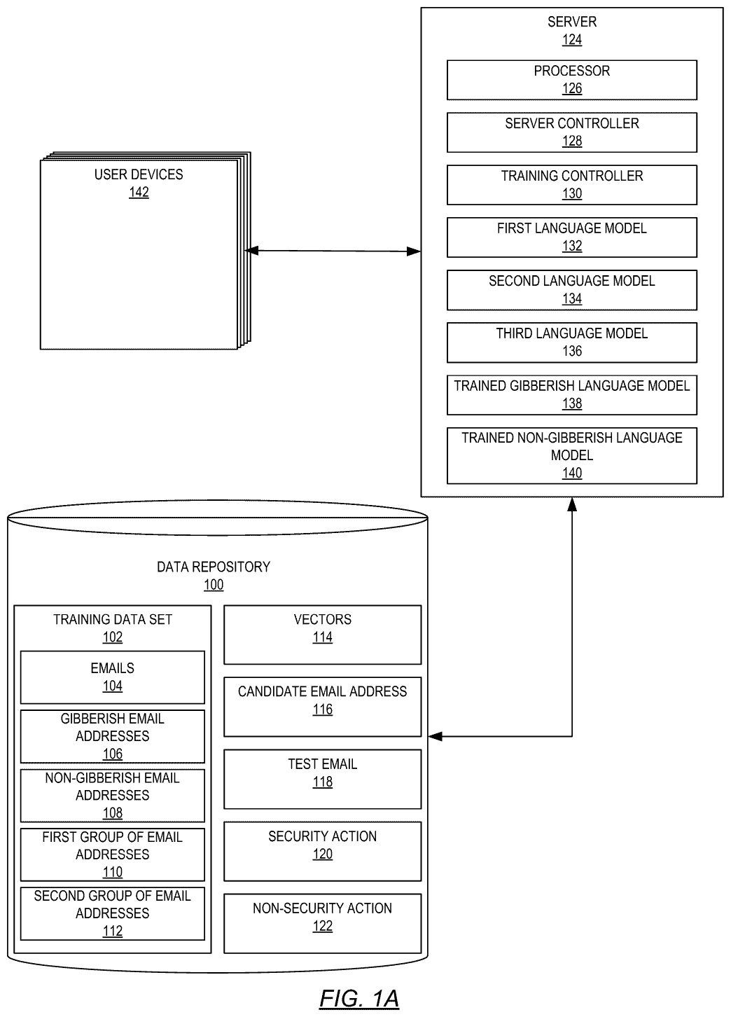

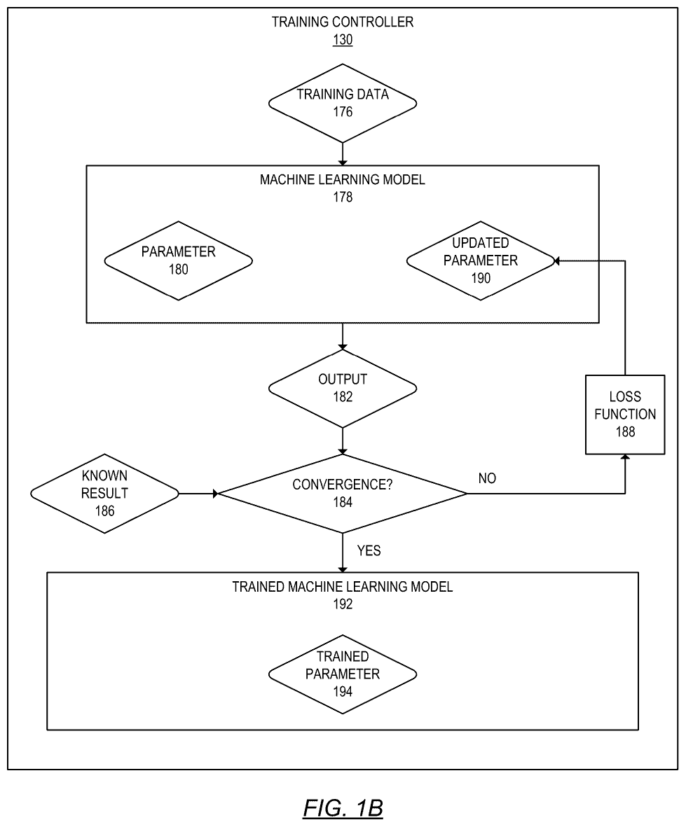

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a training dataset (102). The training dataset (102) is emails (104), or email addresses, useable by machine learning for training, plus possibly other information that may be of use to a language model in predicting whether an email address is valid or invalid. Additionally, the training dataset (102) includes data or metadata indicating a known answer associated with the emails (104) or email addresses. For example, the data within the training dataset (102) may be labeled with labels that indicate that the email addresses (104) in the emails are valid or invalid, and are gibberish or non-gibberish.

The data repository (100) also may store a number of emails (104). The emails (104) are electronic messages which may be routed over a network via an email service including multiple communication layers. Each of the emails (104) includes at least one email address. One or more of the emails (104) may include both valid and invalid email addresses, both gibberish and non-gibberish email addresses, or a combination thereof.

Thus, the training dataset (102) may include a number of gibberish email addresses (106) extracted from the emails (104). A gibberish email address (106) is defined as an email address which includes a text string that a language model classifies as nonsensical or meaningless. The text string may be alphanumeric or special characters that are allowed by an email service to be used in an email address. An example of a gibberish email address (106) may be “17652abc@serverprovider.com,” though gibberish email addresses may take many different forms.

Thus, the training dataset (102) may include a number of non-gibberish email addresses (108) extracted from the emails (104). A non-gibberish email address (108) is defined as an email address which includes a text string that a language model classifies as non-gibberish. The text string may be alphanumeric or special characters that are allowed by an email service to be used in an email address. An example of a non-gibberish email address may be “firstname.lastname@serverprovider.com,” though non-gibberish email addresses may take many different forms.

The training dataset (102) also may store a first group of email addresses (110). The first group of email addresses (110) is a set of invalid email addresses contained within the emails (104) of the training dataset (102). The first group of emails (110) may include both gibberish email addresses (106) and non-gibberish email addresses (108). In other words, invalid email addresses may be gibberish email addresses (106) or non-gibberish email addresses (108).

As used herein, a “valid” email address is associated with a working, non-malicious email account. As used herein, an “invalid” email address is not associated with a working, non-malicious email account.

The training dataset (102) also may store a second group of email addresses (112). The second group of email addresses (112) is a set of valid email addresses contained within the emails (104) of the training dataset (102). The second group of emails (112) may include both gibberish email addresses (106) and non-gibberish email addresses (108). In other words, valid email addresses may be gibberish email addresses (106) or non-gibberish email addresses (108).

The data repository (100) also may store one or more vectors (114). The vectors (114) are computer readable data structures suitable for use by machine learning models. A vector may take the form of a matrix, an array, a graph, or some other data structure. However, a frequently used vector form is a one by an N matrix, where each cell of the matrix represents the value for one feature.

A feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

Data, in a variety of forms, may be transformed into the vectors (114) in a process known as embedding or vectorization. Embedding may be performed by an embedding machine learning model. The data, once embedded, may be referred to as embedded data.

In one or more embodiments the vectors (114) are embedded versions of the training dataset (102), the emails (104), the gibberish email addresses (106), the non-gibberish email addresses (108), the first group of email addresses (110), or the second group of email addresses (112). The vectors (114) also may include additional information, such as labels that describe the email addresses as valid or invalid.

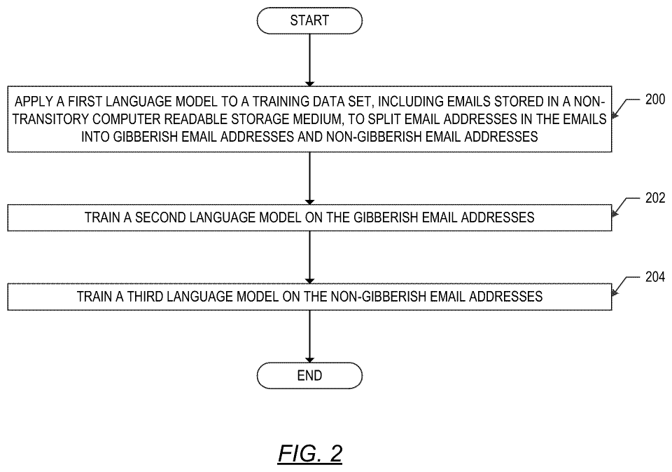

The data repository (100) also may store a candidate email address (116). The candidate email address (116) is an email address which is being analyzed to determine whether the candidate email address (116) is valid or invalid. The candidate email address (116) is thus an email address, but named for convenient reference with respect to the methods described herein. The candidate email address (116), in particular, is referenced with respect to the process of labeling email addresses as part of a data pre-processing step prior to training the machine learning models as described with respect to FIG. 2.

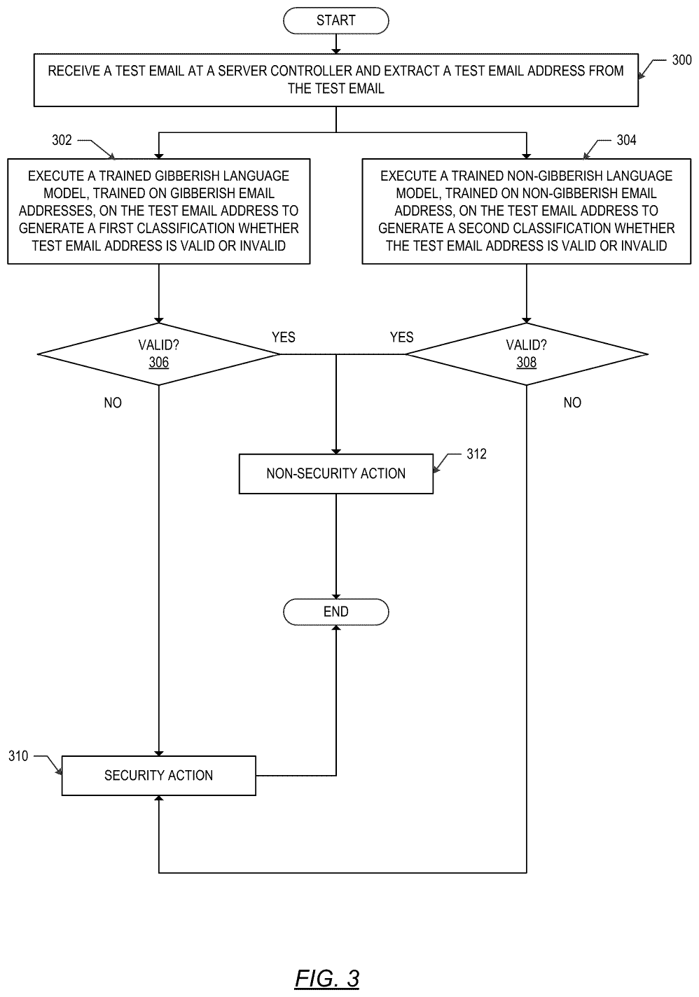

The data repository (100) also may store a test email (118). The test email (118) is an email subject to the method of FIG. 3 to determine whether the test email (118) is valid or invalid. Thus, the test email (118) is an email address, but is named for convenient reference with respect to the method of FIG. 3, which may be an inference stage of machine learning.

The training of machine learning models may be referred to as a training phase. The use of machine learning models to predict information about data may be referred to as an inference phase. The process of preparing the training dataset (102) for the training phase may be referred to as a data pre-processing phase.

The data repository (100) also may store instructions for performing a security action (120). The security action (120) is a set of computer-executable instructions that performs a computer-executed function with respect to one or more of the emails (104) or one or more of the email addresses. The security action (120) may be to limit the effect of the email or email address. For example, the security action (120) may be to delete an email address, block an email containing the email address, label an email as having a suspicious or invalid email address, route an email having an invalid email address to junk email box, or some other security action.

The data repository (100) also may store instructions for performing a non-security action (122). The non-security action (122) is a set of computer-executable instructions that performs a computer-executed function with respect to one or more of the emails (104) or one or more of email addresses. The non-security action (122) may be to avoid limiting the effect of the email or email address. For example, the non-security action (122) may be to store an email address, permit transmission of an email containing the email address, label an email as being from a valid email address, route an email having an invalid email address to a particular email box, or some other non-security action.

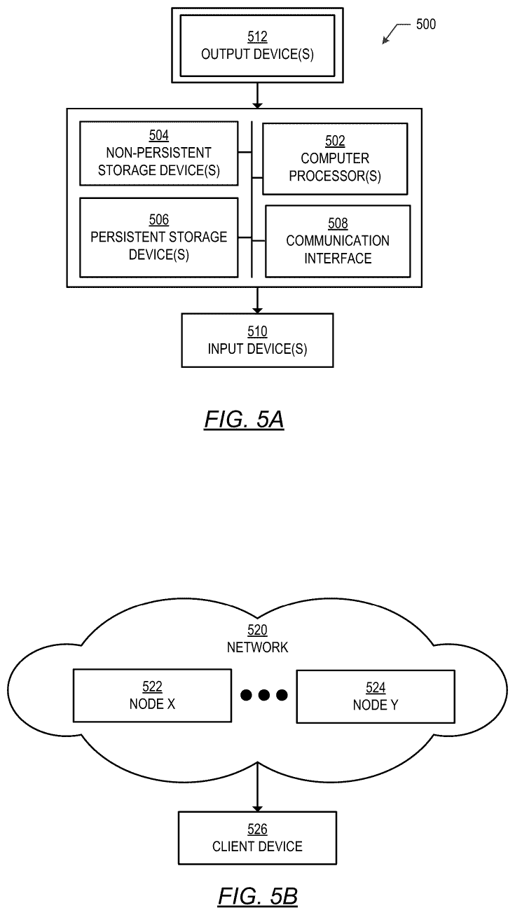

The system shown in FIG. 1A may include other components. For example, the system shown in FIG. 1A also may include a server (124). The server (124) is one or more computer processors, data repositories, communication devices, and supporting hardware and software. The server (124) may be in a distributed computing environment. The server (124) is configured to execute one or more applications, such as the training controller (130), the first language model (132), the second language model (134), the third language model (136), the trained gibberish language model (138), or the trained non-gibberish language model (140). An example of a computer system and network that may form the server (124) is described with respect to FIG. 5A and FIG. 5B.

The server (124) includes a computer processor (126). The computer processor (126) is one or more hardware or virtual processors (126) which may execute computer readable program code that defines one or more applications, such as the training controller (130), the first language model (132), the second language model (134), the third language model (136), the trained gibberish language model (138), or the trained non-gibberish language model (140). An example of the computer processor (126) is described with respect to the computer processor(s) (502) of FIG. 5A.

The server (124) also may include a server controller (128). The server controller (128) is software or application specific hardware which, when executed by the computer processor (126), controls and coordinates the operation of the software or application specific hardware described herein. Thus, the sever controller (128) may control and coordinate execution of the first language model (132), the second language model (134), the third language model (136), the trained gibberish language model (138), and the trained non-gibberish language model (140).

The server (124) also may include a training controller (130). The training controller (130) is software or application specific hardware which, when executed by the computer processor (126), trains one or more machine learning models (e.g., the first language model (132), the second language model (134), the third language model (136), the trained gibberish language model (138), and the trained non-gibberish language model (140)). The training controller (130) is described in more detail with respect to FIG. 1B.

The server (124) also includes a number of language models. A language model is a natural language processing machine learning model. An example of a language model may be a large language model, such as CHATGPT®. However, many different language models may be used, including statistical language models, neural language models, and transformer language models.

One or more embodiments refer to one or more different language models, such as the first language model (132), the second language model (134), and the third language model (136). Each of the language models may start with a similar type of language model (e.g., a natural language processing model). Each of the first language model (132), the second language model (134), and the third language model (136) may, prior to training according to the method of FIG. 2, be the same language model. However, training the language models according to the method of FIG. 2 transforms the language models into different models that form different predictions form the same input data. Thus, the first language model (132), the second language model (134), and the third language model (136) are different language models, even if the underlying structure of the language models started from the same progenitor language model.

In a specific embodiment, each of the language models (i.e., the first language model (132), the second language model (134), and the third language model (136)) may be a bidirectional encoder representations from transformers (BERT) model augmented with a fully connected layer, a neuron layer including at least two neurons, and a softmax layer as a final layer of the second language model.

In general, a BERT model includes three modules: an embedding module, a decoder stack, and a decoder stack. The embedding module converts an array of one-hot encoded tokens into an array of real-valued vectors representing the tokens. A token is a word, a phrase, a letter, etc. The embedding module represents the conversion of discrete token types into a lower-dimensional Euclidean space.

The encoder module is a sequence of transformer encoder blocks. The transformer encoder blocks perform transformations over the array of representation vectors, one of which is bi-directional self-attention.

The decoder module converts the final representation vectors into one-hot encoded tokens again by producing a predicted probability distribution over the token types. The decoder module decodes the latent representation into token types.

In one or more embodiments, the fully connected layer, the neuron layer, and the softmax layer are added to the BERT model in order to improve the performance of the BERT model with respect to accurately predicting whether gibberish or non-gibberish emails are valid or invalid. The fully connected layer and the neuron layer are programmed to draw inferences between invalid email addresses or valid email addresses and other aspects of the emails (104) in the training dataset (102). The softmax layer converts the outputs of the prior layer into a set of numbers that add to one, thereby outputting probabilities representing whether the gibberish email addresses are valid or invalid.

The design of a fully connected layer, followed by a softmax layer, converts an embedding vector into a classifier. In an example, a fully connected layer with a size of 2 represents the score for each class, while the softmax layer converts the scores into probabilities. Thus, the modified machine learning model may act as an improved classifier model.

Returning to the five language models shown in FIG. 1A, the first language model (132) is a language model, which may be the modified BERT model described above. However, the first language model (132) is used to initially classify whether an email address is one of the gibberish email addresses (106) or one of the non-gibberish email addresses (108). In an embodiment, the first language model (132) may be trained on all of the addresses in the emails (104), including both the gibberish email addresses (106) and the non-gibberish email addresses (108).

The second language model (134) is a language model, which may be the modified BERT model described above. However, the second language model (134) will be, or is, fine-tuned by training according to the method of FIG. 2. Thus, the second language model (134) may be trained to determine whether gibberish emails are valid or invalid. The process of training changes the precursor model (e.g., the first language model (132)) into the second language model (134), such that the first language model (132) and the second language model (134) are different models.

The third language model (136) is a language model, which may be the modified BERT model described above. However, the third language model (136) will be, or is, fine-tuned by training according to the method of FIG. 2. Thus, the third language model (136) is trained to determine whether non-gibberish emails are valid or invalid. The process of training changes the precursor model (e.g., the first language model (132)) into the third language model (136), such that the first language model (132), the second language model (134), and the third language model (136) are different models.

The trained gibberish language model (138) is the second language model (134) after training. Thus, the trained gibberish language model (138) is trained to determine whether one of the gibberish email addresses (106) is valid or invalid.

The trained non-gibberish language model (140) is the third language model (136) after training. Thus, the trained non-gibberish language model (140) is trained to determine whether one of the non-gibberish email addresses (108) is valid or invalid.

The system shown in FIG. 1A also may include one or more user devices (142). The user devices (142) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (142) are computing systems (e.g., the computing system (500) shown in FIG. 5A) that communicate with the server (124). The user prompt may be received from one or more of the user devices (142). In another embodiment, one or more of the user devices (142) may be operated by a computer technician that services the various components of the system shown in FIG. 1A.

Attention is turned to FIG. 1B, which shows the details of the training controller (130). The training controller (130) is a training algorithm, implemented as software or application specific hardware, that may be used to train one or more of the machine learning models, encoding networks, or decoding networks described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some pre-determined amount, or until some other termination condition occurs. After training, the final adjusted model is applied to unknown data (i.e., data for which the actual result is not known) in order to make predictions.

Some machine learning models may be applied to vector data structures. A vector is defined above with respect to the vectors (114) of FIG. 1A.

In one or more embodiments, some of the data in the data repository (100) of FIG. 1A may be stored in the form of one or more vectors, such as the vectors (114). For example, the training dataset (102), the emails (104), the gibberish email addresses (106), the non-gibberish email addresses (108), the first group of email addresses (110), and the second group of email addresses (112) may be expressed as the vectors (114).

Returning to the operation of the training controller (130), training starts with training data (176), which may be expressed in vector form. The training data (176) may be data for which the final result is known with certainty. The training data (176) may be the training dataset (102) of FIG. 1A. If the prediction does not match the label, then the weights of the layers in the machine learning model (178) may be updated and the training process iterated.

More generally, the training data (176) is provided as input to the machine learning model (178), which may be the first language model (132), the second language model (134), the third language model (136), the trained gibberish language model (138), or the trained non-gibberish language model (140) of FIG. 1A. The machine learning model (178) may be characterized as a program that has adjustable parameters. The program is capable of learning and recognizing patterns to make predictions. The output of the machine learning model (178) may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a pre-determined end condition of training has been reached. The pre-determined end condition may vary based on the type of machine learning model (178) being used (supervised versus unsupervised machine learning), or may be pre-determined by a user (e.g., convergence occurs after a set number of training iterations, described below).

In the case of supervised machine learning, the convergence process (184) compares the output (182) to a known result (186). The known result (186) is stored in the form of labels for the training data (176). For example, the known result (186) for a particular entry in an output (182) vector of the machine learning model (178) may be a known value, and that known value is a label that is associated with the training data (176).

Continuing the example of supervised machine learning model training, a determination is made whether the output (182) matches the known result (186) to a pre-determined degree. The pre-determined degree may be an exact match, a match to within a pre-specified percentage, or some other metric for evaluating how closely the output (182) matches the known result (186). Convergence may occur when the known result (186) matches the output (182) to within a pre-specified percentage. When many predictions are involved convergence may occur when more than a threshold number of predictions correctly match the corresponding labels.

For example, the threshold may be 95%. In this case, when the machine learning model (178) accuracy reaches 95% then convergence occurs.

In the case of unsupervised machine learning (e.g., one or more of the set of machine learning models of FIG. 1A), the convergence process (184) may be compared to the output (182) or to a prior output (182) in order to determine a degree to which the current output (182) changed relative to the immediately prior output (182) or to the original output (182). Once the degree of change fails to satisfy the threshold degree of change, then the machine learning model (178) may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). The program may be an algorithm which attempts to guess how the parameter (180) may be changed so that the next execution of the machine learning model (178), using the training data (176) with the updated parameter (190), will have an output (182) that is more likely to result in convergence. In this manner, the next execution of the machine learning model (178) is more likely to match the known result (186) (supervised learning), or which is more likely to result in an output (182) that more closely approximates the prior output (one unsupervised learning technique), or which otherwise is more likely to result in convergence.

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment (i.e., the inference phase of machine learning), the trained machine learning model (192) with the trained parameter (194) is executed again, but this time on unknown data (which may be in the form of an unknown data vector) for which the final result is not known. The output of the trained machine learning model (192) is then treated as a prediction of the information of interest relative to the unknown data.

While FIG. 1A and FIG. 1B show a configuration of components, other configurations may be used without departing from the scope of one or more embodiments. For example, various components may be combined to create a single component. As another example, the functionality performed by a single component may be performed by two or more components.

FIG. 2 and FIG. 3 show flowcharts of a method for training and using an ensemble machine learning model for email cybersecurity, in accordance with one or more embodiments. The methods of FIG. 2 and FIG. 3 may be implemented using the system of FIG. 1, and one or more of the steps may be performed on or received at one or more computer processors.

Attention is first turned to FIG. 2, which may be characterized as a method for training an ensemble machine learning model. Step (200) includes applying a first language model to a training data set, including emails stored in a non-transitory computer readable storage medium, to split email addresses in the emails into gibberish email addresses and non-gibberish email addresses. The gibberish email addresses include a first text string that the first language model classifies as gibberish. The non-gibberish email addresses include a second text string that the first language model classifies as non-gibberish.

The first language model may be applied by inputting the emails to the language model. For example, a prompt may instruct the language model to split the email addresses into gibberish email addresses and non-gibberish email addresses. The prompt also may include a source of the email addresses to reference, or may contain the email addresses themselves. The prompt also may include a system message that provides context or additional instructions regarding how the language model is to analyze the emails (e.g., to specify that the language model is to act as if it is a cyber security system that errs on the side of determining that an email address is invalid). The prompt also may include other instructions, such as the data structure format in which the output of the language model is to be given. Other instructions are also possible.

Step (202) includes training a second language model on the gibberish email addresses. The second language model is trained to determine whether the gibberish email addresses are valid or invalid. Training proceeds according to the technique shown in FIG. 1B. However, the training data set is the emails and email addresses for which the validity or invalidity of the gibberish email addresses is already known. Furthermore, the training data set is limited to gibberish email addresses.

The second language model, prior to training the second language model, may be pre-trained to determine whether the email addresses are valid or invalid. In other words, the pre-training includes implementing the training procedure of FIG. 1B on an initial language model. The training data in this case is all of the email addresses, whether gibberish or non-gibberish. In this variation, training the second language model on the gibberish email addresses fine-tunes the second language model.

Step (204) includes training a third language model on the non-gibberish email addresses. The third language model is trained to determine whether the non-gibberish email addresses are valid or invalid. Training proceeds according to the technique shown in FIG. 1B. However, the training data set is the emails and email addresses for which the validity or invalidity of the non-gibberish email addresses is already known. Furthermore, the training data set is limited to non-gibberish email addresses.

The third language model, prior to training, may be pre-trained to determine whether the email addresses are valid or invalid. In other words, the pre-training includes implementing the training procedure of FIG. 1B on an initial language model. The training data in this case is all of the email addresses, whether gibberish or non-gibberish. In this variation, training the third language model on the gibberish email addresses fine-tunes the third language model.

Additional pre-processing may be performed with respect to step (202) or step (204) of FIG. 2. For example, assume that the emails include a first group of email addresses that are labeled as being invalid and a second group of email addresses that are labeled as being valid. Both the first group and the second group include at least some of the gibberish email addresses and at least some of the non-gibberish email addresses.

In this case, the method also may include generating, prior to applying the first language model, the first group of email addresses and the second group of the email addresses. Generating the first group of email addresses and the second group of email addresses is performed by determining whether the email addresses of the emails have confirmed email addresses that are confirmed to be valid or have unconfirmed email addresses unconfirmed as valid. Then, the method includes labeling, as being members of the first group of email addresses, the confirmed email addresses.

In another embodiment, generating the first group of email addresses and the second group of email addresses is performed by a supplemental method. The supplemental method includes receiving a set of raw emails which have not been labeled as valid or invalid. The supplemental method also includes receiving entity identifications. Each of the entity identifications is associated with at least one of the set of raw emails.

The supplemental method also includes determining whether each email address in the set of raw emails is associated with at least two of the entity identifications. The supplemental method also includes labeling, as candidate email addresses, ones of the each email address that are associated with the at least two of the entity identifications.

The supplemental method also may include embedding candidate emails of the candidate email addresses, together with entity information of first entities corresponding to the candidate emails, into vectors. The supplemental method also may include embedding known valid email addresses of the candidate emails, together with entity information of second entities corresponding to the known valid email addresses, into additional vectors.

In this case, generating the first group of email addresses and the second group of email address is further performed by determining variances between the first vectors and the second vectors. Then, the supplemental method also includes labeling, as belonging to the first group, a first sub-group of the first vectors that have a corresponding variance above a threshold variance. The supplemental method also may include labeling, as belonging to the second group, a second sub-group of the first vectors that have a corresponding variance below the threshold variance.

Attention is now turned to FIG. 3. FIG. 3 may be characterized as an inference phase of machine learning, in which the trained second language model and the trained third language model are put to use analyzing whether a test email address is valid or invalid. FIG. 3 also may include treatment of the test email associated with the test email address.

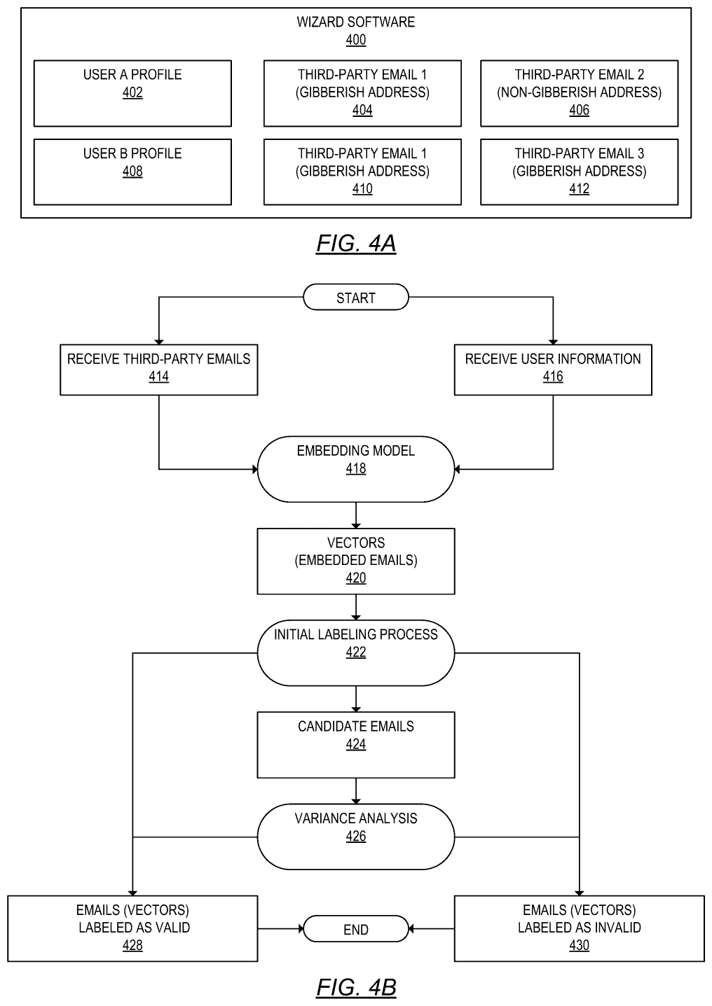

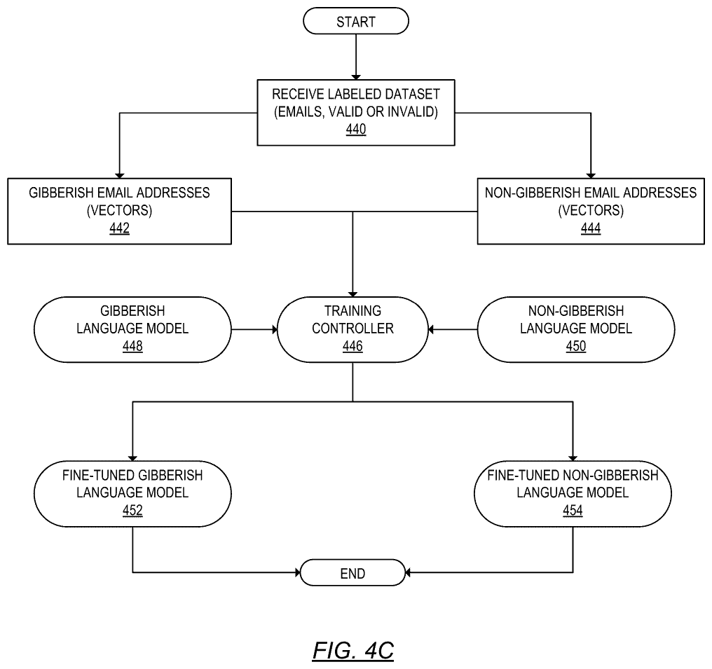

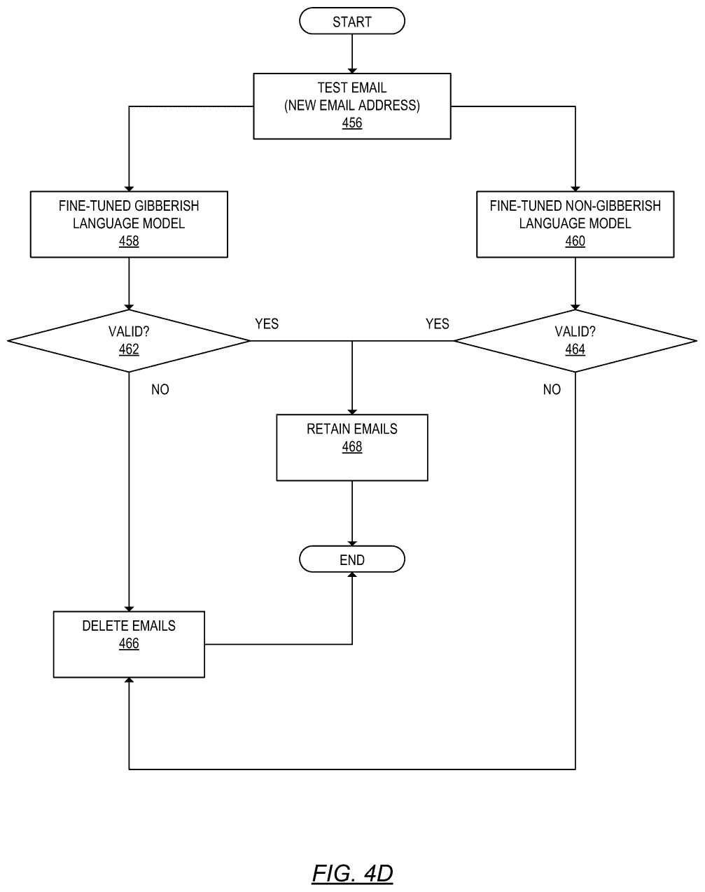

Step (300) includes receiving a test email at a server controller and extracting a test email address from the test email. The test email may be received by retrieving the test email from a data repository storing emails that are to be analyzed. An example of analyzing such email is shown with respect to FIG. 4A through FIG. 4D.

However, receiving the test email may be performed by receiving an email, such as receiving an email at a cyber security system. The test email also may be forwarded to a system for analyzing emails for validity or invalidity, such as the system of FIG. 1A. In these cases, the email address may be extracted from the email.

Step (302) includes executing a trained gibberish language model, trained on gibberish email addresses, on the test email address to generate a first classification whether the test email address is valid or invalid. Executing the trained gibberish language model may be performed as described with respect to step (200) of FIG. 2. However, the input to the trained gibberish language model is the test email. If the trained gibberish language model is a large language model, then the input also may include a prompt, as described above.

Step (304) includes executing a trained non-gibberish language model, trained on non-gibberish email addresses, on the test email address to generate a second classification whether the test email address is valid or invalid. Executing the trained non-gibberish language model may be performed as described with respect to step (200) of FIG. 2. However, the input to the trained gibberish language model is the test email. If the trained gibberish language model is a large language model, then the input also may include a prompt, as described above.

At either step (302) or (304), at least one of the trained gibberish language model and the trained non-gibberish language model is a bidirectional encoder representations from transformers (BERT) model augmented with a fully connected layer, a neuron layer including at least two neurons, and a softmax layer as a final layer. Thus, the models may be modified and trained specifically to predict a probability that the gibberish email addresses are valid or the non-gibberish email addresses are valid.

Step (306) is a determination whether the gibberish email address is valid or invalid. The determination is made by comparing the probability output by the trained gibberish language model to a threshold value (e.g., 51%, 99%, etc.). If the probability satisfies the threshold, then the email is determined to be valid (a “yes” determination at step (306)). Alternatively, if the probability fails to satisfy the threshold, then the email is determined to be invalid (a “no” determination at step (306)).

As used herein, the term “satisfies a threshold” means that the number in question satisfies a pre-determined, quantitative assessment between the number and the threshold. For example, a threshold may be satisfied when the number is above the threshold. However, the threshold may be satisfied when the number is equal to or above the threshold. In contrast, in another embodiment, the threshold may be satisfied when the number is below, or equal to or below the threshold. The exact pre-determined quantitative assessment used may depend on the specific application of one or more embodiments.

Step (308) is a determination whether the non-gibberish email address is valid or invalid. The determination is made by comparing the probability output by the trained non-gibberish language model to a threshold value (e.g., 51%, 99%, etc.). The threshold value used for the validity test for the non-gibberish email address may be different than the threshold value for the validity test for the gibberish email address used at step (306). If the probability determined at step (308) satisfies the threshold used at step (308), then the email is determined to be valid (a “yes” determination at step (308)). Alternatively, if the probability fails to satisfy the threshold, then the email is determined to be invalid (a “no” determination at step (306)).

Taking steps (306) and (308) as a whole, the method of FIG. 3 classifies the test email address as invalid when either the trained gibberish language model or the trained non-gibberish language model classifies the test email address as invalid. However, the method of FIG. 3 classifies the test email address as valid when both the trained gibberish language model and the trained non-gibberish language model classify the test email address as valid.

Step (310) includes performing a security action with respect to the test email address when the test email address is classified as invalid. The security action performed may be any of the security actions described with respect to the security action (120) defined in FIG. 1A.

Step (312) includes performing a non-security action with respect to the test email address when the test email address is classified as valid. The non-security action performed may be any of the non-security actions defined with respect to the non-security action (122) defined in FIG. 1A.

While the various steps in the flowcharts of FIG. 2 and FIG. 3 are presented and described sequentially, at least some of the steps may be executed in different orders, may be combined or omitted, and at least some of the steps may be executed in parallel. Furthermore, the steps may be performed actively or passively.

FIG. 4A, FIG. 4B, FIG. 4C, and FIG. 4D show an example of an ensemble machine learning model for email cybersecurity, in accordance with one or more embodiments. The example of FIG. 4A through FIG. 4D may be implemented using the system of FIG. 1A and FIG. 1B. Aspects of the example of FIG. 4A through FIG. 4D may be performed using the methods of FIG. 2 and FIG. 3. The following example is for explanatory purposes only and not intended to limit the scope of one or more embodiments.

Referring to FIG. 4A, a business entity maintains online accounting software known as wizard software (400). A variety of user profiles are stored for use with the wizard software (400). The profiles include user A profile (402), which references a variety of third-party email addresses which with whom the corresponding user of the wizard software (400) interacts. The third-party email addresses include third-party email 1 (404), which has a gibberish email address. The third-party email addresses also include a third-party email 2 (406), which has a non-gibberish email address.

The profiles also include user B profile (404), which references a variety of third-party email addresses which with whom the corresponding user of the wizard software (400) interacts. The third-party email addresses for the user B profile (404) also includes a third-party email 1 (410), which is the same gibberish email address included for the user A profile (402). However, a different reference numeral is assigned to the third-party email 1 (410) for the user B profile (408), relative to the same for the user A profile (402), in order to show that the same email address is associated with multiple different user profiles. The third-party email addresses also include a third-party email 3 (412), which has a non-gibberish email address.

The wizard software (400) may include many different user profiles. Each of the user profiles may include one or more email addresses, including the email addresses of the users in the user profiles. Each of the user profiles may have more or fewer third-party emails than those shown.

Attention is turned to FIG. 4B, which is a pre-processing method of developing training data for a training process, such as the method of FIG. 2 or the method of FIG. 4C, below. At step (414), third-party emails associated with various user profiles of the wizard software (400) are received. User information (416), also associated with the user profiles of the wizard software (400), is also received.

The combination of the third-party emails and the user information is provided to an embedding model (418). The embedding model may be a word2vec model, or may be a language model in some instances, though other embedding models may be used. In any case, the embedding model (418) is executed by a processor on the third-party emails and the user information.

The output of the embedding model (418) is one or more vectors (420). The vectors are thus embedded versions of the emails, including the email addresses, email subject lines, email bodies, and various user information from the user profiles of the wizard software (400).

The vectors (420) are provided to an initial labeling process (422). The initial labeling process may include determinative programming (e.g., rules or policies) that, when executed by a processor, determine that some (or all) of the email addresses in the vectors (420) are valid or invalid. For example, email addresses shared by multiple users (e.g., the third-party email 1 (404) associated with the user A profile (402) and the third-party email 1 (410) associated with the user B profile (408)) may be determined to be valid. Thus, such emails are labeled at step (428) as being valid. The email addresses labeled as valid are stored.

However, another rule or policy may determine that some of the email addresses in the email are invalid. For example, the third-party email 2 (406) includes a non-gibberish email address that corresponds to a known malicious user. Thus, the email address associated with the third-party email 2 (406) may be labeled as invalid at step (430). The email addresses labeled as invalid are stored.

After the initial labeling process of step (422), the remaining emails are referred to as candidate emails (424) (which remain in vector form). The candidate emails (424) are subjected to a variance analysis at step (426), or to some other analysis, to determine if the candidate emails have valid email addresses or invalid email addresses.

For example, the candidate emails (424) may be input to a pre-trained language model to classify the emails as having valid email addresses or invalid email addresses. If two of the vectors (420) refer to the same entity (i.e., a vector has a low variance compared to another vector), then the email is labeled as valid. Otherwise, the email is labeled as invalid.

Still further, the candidate emails may be labeled by other processes. However, the final result is that some of the emails (vectors) are labeled as valid at step (428), and the remainder of the emails (vectors) are labeled as invalid at step (430). In an embodiment, the method of FIG. 4B may terminate thereafter.

In an embodiment, in order to create or further augment the learning data set (i.e., the labeled emails described above), known features (name, phone, and address) and an existing identity matching model also may be used to create the learning data set. For example, the known features may be used to create false emails as examples of non-valid emails. In particular, the matching model matches existing identities to the known features, so that the generated emails contain substantial true information. However, the generated emails are deliberately altered, perhaps by adding or deleting an alphanumeric character.

Thus, the generated labeled dataset includes emails that are known to be false. The false emails will help the subsequent training of the gibberish language model and non-gibberish language model described above and further described with respect to FIG. 4C, below. In particular, the model's parameters will adjust, during training, such that the model will be better at inference time at determining whether new emails are valid or invalid. The above-described method for labeling may be used to identify new patterns, of both gibberish and non-gibberish alphanumeric text in emails, which are not common or known.

Attention is now turned to FIG. 4C, which refers to a method of training multiple language models for classifying email addresses as valid or invalid. At step (440), a labeled dataset is received. The dataset is emails that are labeled as valid or invalid, per the method of FIG. 4B.

Next, a language model (e.g., the first language model (132) of FIG. 1A) is executed on the received labeled dataset. The language model is prompted or instructed to identify gibberish versus non-gibberish email addresses within the received emails. The language model is prompted or instructed to split the email addresses into the gibberish email addresses and the non-gibberish email addresses.

The gibberish email addresses (442) are provided to a training controller (446). The training controller (446) trains a gibberish language model (448) on the gibberish email addresses (442) according to the training procedure described with respect to FIG. 1B.

The non-gibberish email addresses (444) are provided to the training controller (446). The training controller (446) trains a non-gibberish language model (450) on the non-gibberish email addresses (444) according to the training procedure described with respect to FIG. 1B.

The result of training is a fine-tuned gibberish language model (452) and a fine-tuned non-gibberish language model (454). The term “fine-tuned” means that the pre-trained model (i.e., the gibberish language model (448) and the non-gibberish language model (450)) is refined through training, and thus can more accurately classify emails as valid or invalid. Specifically, the fine-tuned gibberish language model (452) is more accurate than the pre-trained model with respect to classifying gibberish emails as valid or invalid. Similarly, the fine-tuned non-gibberish language model (454) is more accurate than the pre-trained model with respect to classifying non-gibberish emails as valid or invalid. In any case, the method of FIG. 4C terminates thereafter.

Attention is turned to FIG. 4D, which represents an example of an inference phase of machine learning in which the fine-tuned models trained in the method of FIG. 4C are used to classify a test email. Initially, a test email (456) having a new email address is received. The email is received by processing an email in a data repository, such as the wizard software (400) of FIG. 4A. However, in another example, the email may be received as a live incoming email which is intercepted by a cybersecurity system.

The test email (456) is provided as input to a fine-tuned gibberish language model (458). The test email (456) is also provided as input to a fine-tuned non-gibberish language model (460). The two language models are executed, and each makes a determination whether the test email address of the test email (456) is valid or invalid.

At step (462) a determination is made whether the fine-tuned gibberish language model (458) predicted that the test email address is valid or invalid. For example, the output of the fine-tuned gibberish language model (458) may be compared to a threshold value. If the threshold value is satisfied, then the test email address is valid (a “yes” determination at step (462)). However, if the threshold value is not satisfied, then the test email address is invalid (a “no” determination at step (462)).

At step (464) a determination is made whether the fine-tuned non-gibberish language model (460) predicted that the test email address is valid or invalid. For example, the output of the fine-tuned non-gibberish language model (460) may be compared to a threshold value (which may be different than the threshold value used in step (462)). If the threshold value is satisfied, then the test email address is valid (a “yes” determination at step (464)). However, if the threshold value is not satisfied, then the test email address is invalid (a “no” determination at step (464)). Step (462) and step (464) may be performed concurrently.

If the test email address is predicted to be valid at both step (462) and (464), then the test email address is deemed valid. The test email (456) associated with the test email address is retained (e.g., stored in a non-transitory computer readable storage medium). The valid test email then may be used in other processes (e.g., to contact the corresponding users). The process may terminate thereafter.

However, if the test email address is predicted to be invalid at either step (462) or (464), then the test email address is deemed invalid. The test email (456) associated with the test email address is deleted (e.g., removed from a non-transitory computer readable storage medium). In this manner, the invalid test email will not cause technical problems in later processing of the emails associated with the user profiles of the wizard software (400) described in FIG. 4A. The process may terminate thereafter.

The method of FIG. 4D may be varied. For example, instead of the dual test shown in FIG. 4D, the test email address may be classified as gibberish or non-gibberish. Then, a single fine-tuned model may be used to predict whether the test email address is valid or invalid. Specifically, the fine-tuned gibberish language model (458) is used to determine if the test email address is valid or invalid when the test email address is a gibberish email address. However, the fine-tuned non-gibberish language model (460) is used to determine if the test email address is valid or invalid when the test email address is a non-gibberish email address.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system (500) shown in FIG. 5A, or a group of nodes combined may correspond to the computing system (500) shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system (500) shown in FIG. 5A. Further, the client device (526) may include or perform all or a portion of one or more embodiments.

The computing system (500) of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method for training an ensemble machine learning model, the method comprising:
applying a first language model to a training data set, comprising emails stored in a non-transitory computer readable storage medium, to split email addresses in the emails into gibberish email addresses and non-gibberish email addresses, wherein:
the gibberish email addresses include a first text string that the first language model classifies as gibberish, and
the non-gibberish email addresses include a second text string that the first language model classifies as non-gibberish;
training a second language model on the gibberish email addresses, wherein the second language model is trained to determine whether the gibberish email addresses are valid or invalid; and
training a third language model on the non-gibberish email addresses, wherein the third language model is trained to determine whether the non-gibberish email addresses are valid or invalid.

2. The method of claim 1, wherein the second language model comprises a bidirectional encoder representations from transformers (BERT) model augmented with a fully connected layer, a neuron layer comprising at least two neurons, and a softmax layer as a final layer of the second language model.

3. The method of claim 2, wherein the softmax layer outputs probabilities representing whether the gibberish email addresses are valid.

4. The method of claim 1, wherein the third language model comprises a bidirectional encoder representations from transformers (BERT) model augmented with a fully connected layer, a neuron layer comprising at least two neurons, and a softmax layer as a final layer of the second language model.

5. The method of claim 4, wherein the softmax layer outputs probabilities representing whether the gibberish email addresses are valid.

6. The method of claim 1, wherein the second language model is different than the third language model.

7. The method of claim 1, wherein:
the second language model, prior to training the second language model, is pre-trained to determine whether the email addresses are valid or invalid, and
training the second language model on the gibberish email addresses fine-tunes the second language model.

8. The method of claim 7, further comprising:
pre-training the second language model on the emails to determine whether the email addresses are valid or invalid.

9. The method of claim 1, wherein:
the third language model, prior to training the second language model, is pre-trained to determine whether the email addresses are valid or invalid, and
training the third language model on the non-gibberish email addresses fine-tunes the third language model.

10. The method of claim 9, further comprising:
pre-training the third language model on the emails to determine whether the email addresses are valid or invalid.

11. The method of claim 1 wherein the emails include a first group of email addresses that are labeled as being invalid a second group of email addresses that are labeled as being valid, wherein both the first group and the second group include at least some of the gibberish email addresses and at least some of the non-gibberish email addresses, and wherein the method further comprises:
generating, prior to applying the first language model, the first group of email addresses and the second group of the email addresses.

12. The method of claim 11, wherein generating the first group of email addresses and the second group of email addresses is performed by:
determining whether email addresses of the emails have confirmed email addresses that are confirmed to be valid or have unconfirmed email addresses unconfirmed as valid, and
labeling, as being members of the first group of email addresses, the confirmed email addresses.

13. The method of claim 11, wherein generating the first group of email addresses and the second group of email addresses is performed by:
receiving a set of raw emails,
receiving a plurality of entity identifications, wherein each of the plurality of entity identifications is associated with at least one of the set of raw emails,
determining whether each email address in the set of raw emails is associated with at least two of the plurality of entity identifications, and
labeling, as candidate email addresses, ones of the each email address that are associated with the at least two of the plurality of entity identifications.

14. The method of claim 13, wherein generating the first group of email addresses and the second group of email addresses is further performed by:
embedding candidate emails of the candidate email addresses, together with entity information of first entities corresponding to the candidate emails, into a first plurality of vectors, and
embedding known valid email addresses of the candidate emails, together with entity information of second entities corresponding to the known valid email addresses, into a second plurality of vectors.

15. The method of claim 14, wherein generating the first group of email addresses and the second group of email address is further performed by:
determining a plurality of variances between the first plurality of vectors and the second plurality of vectors,
labeling, as belonging to the first group, a first sub-group of the first plurality of vectors that have a corresponding variance above a threshold variance, and
labeling, as belonging to the second group, a second sub-group of the first plurality of vectors that have a corresponding variance below the threshold variance.

16. A system comprising:
a computer processor;
a data repository in communication with the computer processor and storing:
a training data set comprising emails,
gibberish email addresses of the emails, wherein the gibberish email addresses include first text strings that are classified as nonsensical or meaningless, and
non-gibberish email addresses of the emails, wherein the non-gibberish email address include second text strings that are classified as non-gibberish; and
a first language model which, when executed by the computer processor, performs computer-implemented steps comprising:
splitting the emails into the gibberish email addresses and the non-gibberish email addresses; and
a training controller which, when executed by the computer processor, performs computer-implemented steps comprising:
training a second language model on the gibberish email addresses, wherein the second language model is trained to determine whether the gibberish email addresses are valid or invalid, and
training a third language model on the non-gibberish email addresses, wherein the third language model is trained to determine whether the non-gibberish email addresses are valid or invalid.

17. The system of claim 16, wherein the second language model comprises a bidirectional encoder representations from transformers (BERT) model augmented with a fully connected layer, a neuron layer comprising at least two neurons, and a softmax layer as a final layer of the second language model.

18. The system of claim 16, wherein the third language model comprises a bidirectional encoder representations from transformers (BERT) model augmented with a fully connected layer, a neuron layer comprising at least two neurons, and a softmax layer as a final layer of the third language model.

19. The system of claim 16, wherein the training controller which, when executed by the computer processor, further performs computer-implemented steps comprising:
pre-training, prior to training the second language model, the second language model on the emails to determine whether the email addresses are valid or invalid, and
pre-training, prior to training the third language model, the third language model on the emails to determine whether the email addresses are valid or invalid.

20. A method comprising:
receiving a test email at a server controller and extracting a test email address from the test email;
executing a trained gibberish language model, trained on gibberish email addresses, on the test email address to generate a first classification whether the test email address is valid or invalid;
executing a trained non-gibberish language model, trained on non-gibberish email address, on the test email address to generate a second classification whether the test email address is valid or invalid,
wherein at least one of the trained gibberish language model and the trained non-gibberish language model comprises a bidirectional encoder representations from transformers (BERT) model augmented with a fully connected layer, a neuron layer comprising at least two neurons, and a softmax layer as a final layer;
classifying the test email address as invalid when either the trained gibberish language model or the trained non-gibberish language model classifies the test email address as invalid;
classifying the test email address as valid when both the trained gibberish language model and the trained non-gibberish language model classify the test email address as valid;
performing a security action with respect to the test email address when the test email address is classified as invalid; and
performing a non-security action with respect to the test email address when the test email address is classified as valid.
